(19) United States
(12) Patent Application Publication
(10) Pub. No.: US 2026/0163758 A1
(43) Pub. Date: Jun. 11, 2026

(54) CONNECTION BRIDGING IN A GATEWAY TO SHARE LANS

(71) Applicant: Charter Communications Operating, LLC, St. Louis, MO (US)

(72) Inventor: Timothy Clark Bleidorn-Piper, Colorado Springs, CO (US)

(21) Appl. No.: 18/976,807

(22) Filed: Dec. 11, 2024

(51) Int. Cl. H04L 12/46

(52) U.S. Cl. CPC H04L 12/4625; H04L 12/4633

(57) ABSTRACT

A wireless system as discussed herein communication management hardware associated with a gateway resource. The communication management hardware is operative to, via a first communication path between a first wireless access point and a gateway, provide a first communication device access to a remote network. Via a second communication path between a second wireless access point and the gateway, the communication management hardware is operative to provide a second communication device access to the remote network. In response to receiving a request to support connectivity between the first communication device and the second communication device, the communication management hardware associated with the gateway resource establishes a third communication path in the gateway connecting the first communication path and the second communication path.

### BACKGROUND

In a VCP (Virtual Customer Premises) network architecture, so-called broadband network gateways (a.k.a., BNGs) may be used as the termination point for connected LANs (Local Area Networks). A wireless access point may be used as a means to implement a respective local area network.

One or more local area networks associated with a wireless access point may be tunneled over GRE (Generic Routing Encapsulation) to the BNG (Broadband Network Gateway), where they carry data packets from the one or more instances of user equipment directly through the respective wireless access point to a respective routing function on the BNG. The BNG may serve as the router as well as the network address translation point to translate the privately addressed user equipment data packets to respective target publicly routable IPV (Internet Protocol Version) network addresses and corresponding data packets.

It is noted that conventional networks can be configured to implement a first gateway resource and a second gateway resource providing multiple local area networks access to a public network such as the Internet. For example, a first wireless access point in a network environment can be configured to support a first wireless local area network of first communication devices; a second wireless access point can be configured to support a second wireless local area network of second communication devices.

A first gateway resource can be configured to support first connectivity between the first communication devices through the first wireless access point and the first gateway to a public network independent of the first gateway resource supporting second connectivity between the second communication devices through the second wireless access point and the sec first ond gateway resource to the public network.

### BRIEF DESCRIPTION OF EXAMPLES

This disclosure includes the observation that there exist use cases where so-called ‘joining’ of two disparate Local Area Networks (LANs) across subscriber CPE (Customer Premises Equipment) in a respective gateway resource would beneficially provide more efficient conveyance of data packets, alleviating a need to provide connectivity of multiple wireless local area networks in a public network.

For example, assume that two users live in the same MDU (Multi-Dwelling Unit) property but rent separate units (different subscriber domains) and desire to collectively play a computer game requiring connectivity between their respective user computers over a network. Assume that the users wish to play a so-called LAN (Local Area Network) game, which is to say, a game that requires LAN connectivity between two computers. Techniques herein include providing network services that allow disparately located communication devices executing the LAN game (application) to explicitly connect their computers on the same ‘LAN’ and enjoy their gaming. Further, assume that the first user and corresponding communication device wishes to make its network attached storage (NAS) and corresponding stored data available to the second user and corresponding communication device without the need to configure layer 3 static IP addresses or purchasing a dynamic DNS service. The bridging techniques (such as including one or more bypass paths) as discussed herein beneficially connect multiple local area networks and corresponding communication devices.

One conventional way to provide network connectivity is to implement a physical wire (cable) between the 2 different wireless access points and thus local area networks. In other words, in order for two tenants (users as previously discussed) to share a LAN broadcast domain and IP network address prefix, they would need to physically wire the apartments together (possibly through a hallway).

In contrast to conventional techniques, examples herein include providing connectivity between multiple entities sharing a common gateway (such as a BNG) to communicate with a remote network such that those communication devices do not need to communicate with each other via communications through the remote network such as the Internet. In other words, the supplemental connectivity such as a secured tunnel (such a bypass communication path) in the gateway resource supports conveyance of communications between multiple local area networks, without having to send the communications to or through a public network.

More specifically, a wireless system as discussed herein includes communication management hardware associated with a shared gateway resource. The communication management hardware and network are operative to, via a first communication path between a first wireless access point and the gateway, provide a first communication device access to a remote network. Via a second communication path between a second wireless access point and the gateway, the communication management hardware and network are operative to provide a second communication device access to the remote network. In response to receiving a request to support connectivity between the first communication device and the second communication device, the communication management hardware associated with the gateway resource establishes a third communication path (such as a bypass path), resulting in advantageous connecting of the first communication path and the second communication path.

In a further example, the first communication path may be implemented as a first secure tunnel, where a first endpoint of the first communication path terminates at the first wireless access point and where a second endpoint of the first communication path terminates at the gateway; the second communication path may be implemented as a second secure tunnel, where a first endpoint of the second communication path terminates at the second wireless access point and a second endpoint of the second communication path terminates at the gateway.

Note that the third communication path such as in the gateway resource may be a third secure tunnel having corresponding endpoints in the gateway, where the third secure tunnel is operative to provide connectivity between the second endpoint of the first communication path and the second endpoint of the second communication path. As previously discussed, the third secure tunnel or third communication path supports a bypass option to convey communications between the first local area network and a second local area network.

In still further examples, a combination of the first wireless access point, the second wireless access point, and the gateway may be part of a service provider network in communication with the remote network (such as the Internet or other suitable entity) through a network address translator. The third communication path may beneficially alleviate a need to convey communications through the remote network to support the connectivity between the first communication device and the second communication device.

As further discussed herein, the request for connectivity may be received from any suitable resource or entity. For example, a user of the first communication device in the first subscriber domain in which the first wireless access point resides may transmit the request to a communication management resource managing operation of the gateway. The second wireless access point may reside in a second subscriber domain, which is independent of the first subscriber domain. The first subscriber domain and the second subscriber domain may share the same gateway resource to access a public network such as the Internet. The third communication path in the gateway advantageously connects a first local area network supported by the first wireless access point to a second local area network supported by second wireless access point.

Still further, as discussed herein, the third communication path can be established via the communication management resource receiving the request. The third communication path may be established at least in part in response to or subsequent to transmitting of an invitation message on behalf of the requesting user from a service provider portal through the second communication path and the second wireless access point to the second communication device. The invitation message to the second communication device and a second local area network may include an identity of the first communication device and/or user of the first communication device. The invitation message may further include an inquiry from the user of the first communication device to a user of the second communication device whether to provide the connectivity between the second communication device and the first communication device. Accordingly, certain examples herein include providing notification to the user of the second communication device, where the notification indicates an invitation for the user of the second communication device to join the local area network supported by the first wireless access point.

Still further, the third communication path can be configured to support conveyance of layer 2 communications (of a multi-layer network communication protocol) between the first communication path and the second communication path. The layer 2 communications can be configured to bypass the remote network and directly support conveyance of data between the first communication device and the second communication device via the third communication path provided by the gateway.

Note further that the first wireless access point can be configured to support a first virtual local area network including the first communication device as a first member; the second wireless access point can be configured to support a second virtual local area network including the second communication device as a first member; the first wireless access point can be configured to track the second communication device as a second member of the first virtual local area network; the second wireless network can be configured to track the first communication device as a second member of the second virtual local area network.

Thus, the first wireless access point or other suitable entity can be configured to produce network information indicating members of a first local area network supported by the first wireless access point, the members including the first communication device and the second communication device. The second wireless access point or other suitable entity can be configured to produce network information indicating members of a second local area network supported by the second wireless access point, the members including the second communication device and the first communication device.

Techniques as discussed herein are useful over conventional techniques. For example, one or more implementation of communication management hardware and corresponding operations as discussed herein provide better use of a respective network and corresponding connectivity to more efficiently convey data between networks.

Note that any of the resources as discussed herein can include one or more computerized devices, mobile communication devices, sensors, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different examples as described herein.

Yet other examples herein include software programs to perform the steps and operations summarized above and disclosed in detail below. One such example comprises a computer program product including a non-transitory computer-readable storage medium or any computer readable hardware storage on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage medium such as an optical medium (e.g., CD-ROM), floppy disk, hard disk, memory stick, memory device, etc., or other medium such as firmware in one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, examples herein are also directed to a method, system, computer program product, etc., that supports operations as discussed herein.

One example as further discussed herein includes a computer readable storage medium and/or system having instructions stored thereon. The instructions, when executed by the computer processor hardware, cause the computer processor hardware (such as one or more co-located or disparately processor devices or hardware) to: via a first communication path between a first wireless access point and a gateway, provide a first communication device access to a remote network; via a second communication path between a second wireless access point and the gateway, provide a second communication device access to the remote network; and in response to receiving a request to support connectivity between the first communication device and the second communication device, establish a third communication path (bypass path) connecting the first communication path and the second communication path.

The ordering of the steps above has been added for clarity sake. Note that any of the processing steps as discussed herein can be performed in any suitable order.

Other examples of the present disclosure include software programs and/or respective hardware to perform any of the method example steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of providing wireless connectivity in a network environment. However, it should be noted that examples herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more inventive concepts as described herein can be implemented and viewed in many different ways.

Also, note that this preliminary discussion of examples herein (BRIEF DESCRIPTION OF EXAMPLES) purposefully does not specify every example and/or incrementally novel aspect of the present disclosure or claimed invention(s). Instead, this brief description only presents general examples and corresponding points of novelty over conventional techniques. For additional details and/or possible perspectives (permutations) of the invention(s), the reader is directed to the Detailed Description section (which is a summary of examples) and corresponding figures of the present disclosure as further discussed below.

### BRIEF DESCRIPTION OF THE DRAWINGS

FIG. 1 is an example diagram illustrating a wireless network environment and implementation of one or more wireless access points providing multiple different communication devices wireless connectivity to a remote network and to each other as discussed herein.

FIG. 2 is an example diagram illustrating an initial state of a respective network environment and generation of an invitation by a first user in a first wireless network for a second user in the second wireless network to join the first wireless network as discussed herein.

FIG. 3 is an example diagram illustrating retrieval of subscriber information and network connection information associated with the first wireless access point and the second wireless access point to establish a bridge connection (bypass communication path) as discussed herein.

FIG. 4 is an example diagram illustrating communications of instructions to a gateway in order to support connectivity of the first wireless access point and the second wireless access point via a bridge connection as discussed herein.

FIG. 5 is an example diagram illustrating implementation of a bridge connection supporting bypass connectivity between multiple different wireless networks as discussed herein.

FIG. 6 is an example diagram illustrating inclusion of a communication device in the second wireless network as a member of the first wireless network as discussed herein.

FIG. 7 is an example diagram illustrating inclusion of a communication device in the first wireless network as a member of the second wireless network as discussed herein.

FIG. 8 is an example diagram illustrating example computer hardware and software operable to execute any operations as discussed herein.

FIG. 9 is an example diagram illustrating a method as discussed herein.

The foregoing and other objects, features, and advantages of the invention will be apparent from the following more particular description of preferred examples herein, as illustrated in the accompanying drawings in which like reference characters refer to the same parts throughout the different views. The drawings are not necessarily to scale, with emphasis instead being placed upon illustrating the examples, principles, concepts, etc.

### DESCRIPTION OF EXAMPLES

A wireless system as discussed herein includes communication management hardware associated with a gateway resource. Via a first communication path between a first wireless access point and a gateway, the communication system as discussed herein provides a first communication device access to a remote network such as the Internet. Via a second communication path between a second wireless access point and the gateway, the communication system as discussed herein provides a second communication device access to the remote network. In response to receiving a request to support connectivity between the first communication device and the second communication device, or connectivity support between the first wireless network and the second wireless network, the communication management hardware associated with the gateway resource can be configured to establish a third communication path (bypass path) in the gateway to advantageously connect the first communication path and the second communication path.

As further discussed herein, the third communication path enables one or more communication devices in a second wireless network (second local area network) to join as a member of a first wireless network (first local area network). Conversely, the third communication path as discussed herein may enable one or more communication devices in a first wireless network (first local area network) to join as a member of a second wireless network (second local area network).

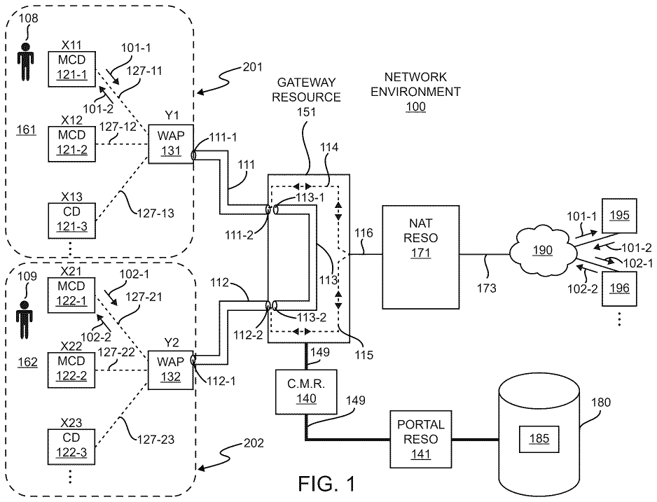

Now, more specifically, FIG. 1 is an example diagram illustrating a network environment and implementation of one or more wireless access points to provide multiple different communication devices connectivity to a remote network and each other as discussed herein.

As shown in FIG. 1, the network environment 100 includes wireless access point 131, wireless access point 132, multiple communication devices 121 (such as mobile communication device 121-1, mobile communication device 121-2, communication device 121-3, etc.) disposed in a first network 201 such as a first virtual local area network supported by the wireless access point 131, multiple communication devices 122 (such as mobile communication device 122-1, mobile communication device 122-2, communication device 122-3, etc.) disposed in a second network 202 such as a second virtual local area network supported by the wireless access point 132, gateway resource 151, communication management resource 140, portal resource 141, repository 180, network address translator resource 171, network 190, and one or more servers such as server 195, server 196, etc.

As further shown, the mobile communication device 121-1 (operated by a first user 108 and assigned the unique network address value X11) is wirelessly connected to the wireless access point 131 via wireless communication link 127-11; the mobile communication device 121-2 (such as operated by a second user or user 108 and assigned the unique network address value X12) is wirelessly connected to the wireless access point 131 via wireless communication link 127-2; the mobile communication device 121-3 (assigned the unique network address value X13) is wirelessly connected to the wireless access point 131 via wireless communication link 127-13; and so on.

The wireless access point 131 or other suitable entity can be configured to maintain a list active list of communication devices supported by the respective network 201. Accordingly, the wireless access point 131 is able to locally support conveyance of communications between each of the members (mobile communication device 121-1, mobile communication device 121-2, communication device 121-3, etc.) in the network 201.

The wireless access point 131 is assigned the unique network address value Y1.

As further shown, the mobile communication device 122-1 (operated by a second user 109 and assigned the unique network address value X21) is wirelessly connected to the wireless access point 132 via wireless communication link 127-21; the mobile communication device 122-2 (such as operated by a second user or user 109 and assigned the unique network address value X22) is wirelessly connected to the wireless access point 132 via wireless communication link 127-22; the mobile communication device 121-3 (assigned the unique network address value X13) is wirelessly connected to the wireless access point 131 via wireless communication link 127-13; and so on.

The wireless access point 132 can be configured to maintain a list active list of communication devices supported by the respective network 202. Accordingly, the wireless access point 132 is able to locally support conveyance of communications between each of the members (mobile communication device 122-1, mobile communication device 122-2, communication device 122-3, etc.) in the network 202.

The wireless access point 132 is assigned the unique network address value Y2.

As further shown, the wireless access point 131 is in communication with the gateway resource 151 via the communication path 111 (such as a first secured tunnel). The wireless access point 132 is in communication with the gateway resource 151 via the communication path 112 (such as a second secure tunnel).

Accordingly, the wireless access point 131 serves as a terminating node for the user equipment (such as communication devices 121). The wireless access point 131 also serves as a terminating node for the communication path 111 such as a secure tunnel (communication path 111) extending between the wireless access point 131 and the gateway resource 151 (where the gateway resource 151 may be implemented as a so-called broadband network gateway or other suitable entity). In one example, a first end point 111-1 of the communication path 111 is disposed at the wireless access point 131; a second end point 111-2 of the communication path 111 is disposed at the gateway resource 151.

Yet further, the wireless access point 132 serves as a terminating node for the user equipment (such as communication devices 122). The wireless access point 132 also serves as a terminating node for the communication path 112 such as a second secure tunnel extending between the wireless access point 132 and the gateway resource 151 (where, as previously discussed, the gateway resource 151 may be implemented as a so-called broadband network gateway or other suitable entity). A first end point 112-1 of the communication path 112 is disposed at the wireless access point 132; a second end point 112-2 of the communication path 112 is disposed at the gateway resource 151.

Accordingly, the first communication path 111 may be a first secure tunnel, where a first endpoint 111-1 of the first communication path 111 terminates at the first wireless access point 131 and where a second endpoint 111-2 of the first communication path 111 terminates at the gateway resource 151; the second communication path 112 may be a second secure tunnel where a first endpoint 112-1 of the second communication path 112 terminates at the second wireless access point 132 and a second endpoint 112-2 of the second communication path 112 terminates at the gateway resource 151.

In further examples as discussed herein, the communication management resource 140 and corresponding gateway resource 151 can be configured to establish the third communication path 113 such as a third secure tunnel having corresponding endpoints inside or outside of the gateway 151.

As shown, the third communication path 113 such as a third secure tunnel can be configured to provide connectivity between the second endpoint 111-2 of the first communication path 111 and the second endpoint 112-2 of the second communication path 112.

Yet further, the gateway resource 151 is in communication with the network address translator resource 171 via the communication path 116. In one example, the network address translator resource 171 and corresponding network address translation functionality is implemented in the gateway resource 151.

The network address translator resource 171 can be configured to provide access to the remote network 190 (such as a so-called public network, which may be the Internet) via implementing, as its name suggests, translation of network addresses. The one or more server resources 195, 196, etc., are accessible to the mobile communication devices and wireless access points through a combination of the gateway resource 151, network address translator resource 171, and the remote network 190.

Thus, as further shown, each of the communication devices in the subscriber domain 161 is able to communicate over a combination of communication paths to one or more respective destinations such as server resource 195, 196, etc.

More specifically, the mobile communication device 121-1 can be configured to transmit a respective communication 101-1 (such as a data packet or other suitable entity) over the wireless communication link 127-11 to the wireless access point 131; the wireless access point 131 forwards the communication 101-1 to the target destination (server 195) via transmission of the communication 101-1 over the communication path 111 to the gateway resource 151; the gateway resource 151 further transmits the communication 101-1 over the communication path 114 and the communication path 116 to the network address translator resource 171; network address translator resource 171, as its name suggests, translates the address associated with the communication 101-1 and forwards the communication 101-1 over the communication path 173 and network 190 to the appropriate target server resource 195.

In a reverse direction, the server resource 195 transmits communications 101-2 (such as a response to the communications 101-1, the response including one or more data packets) through the network 190 and the communication path 173 to the network address translator resource 171; in accordance with the destination as specified by the communications 101-2, the network address translator resource 171 transmits the communications 101-2 over the communication path 116 to the gateway resource 151; the gateway resource 151 transmits the communications 101-2 over the communication path 111 to the wireless access point 131; wireless access point 131 further transmits the communications 101-2 to the mobile communication device 121-1 over the wireless communication link 127-11.

Accordingly, the multiple communication paths in the network environment 100 support connectivity of the mobile communication device 121-1 to one or more server resources in the network 190.

The mobile communication device 122-1 can be configured to transmit a respective communication 102-1 (such as a data packet or other suitable entity) over the wireless communication link 127-21 to the wireless access point 132; the wireless access point 132 forwards the communication 102-1 to the target destination (such as server 196) via transmission of the communication 102-1 over the communication path 112 to the gateway resource 151; the gateway resource 151 transmits the communications 102-1 over the communication path 115 and the communication path 116 to the network address translator resource 171; network address translator resource 171, as its name suggests, translates the address associated with the communication 102-1 and forwards it over the communication path 173 and network 190 to the target server resource 196.

In a reverse direction, the server resource 196 transmits communications 102-2 (response to the communications 102-1 such as one or more data packets) through the network 190 and the communication path 173 to the network address translator resource 171; in accordance with the destination as specified by the communications 102-2, the network address translator resource 171 transmits the communications 102-2 over the communication path 116 to the gateway resource 151; the gateway resource 151 transmits the communications 102-2 over the communication path 112 to the wireless access point 132; wireless access point 132 transmits the communications 102-2 to the mobile communication device 122-1 over the wireless communication link 127-21.

Accordingly, the multiple communication paths in the network environment 100 support connectivity of the mobile communication device 122-1 to one or more server resources in the network 190.

In accordance with one example, the gateway resource 151 or BNG control plane implemented by the communication management resource 140 associated with the network, in general, is responsible for management functions of the BNG user planes, including facilitating setup of the communication path 113 between the communication path 111 and the communication path 112 such that communications between the mobile communication devices 121-1 and 122-1 do not need to be transmitted through the network 190.

Note further that the repository 180 can be configured as a subscriber database such as storing subscriber information 185 used by the BNG control plane (149) as a data store. The BNG control plane and/or the portal resource 141 can be configured to reference or access the subscriber database (and subscriber information 185 stored in repository 180) when needed in order to determine whether or not to establish a bypass communication path such as communication path 113 between wireless access points and corresponding supported local area networks.

Note that the resources as discussed herein can be implemented in any suitable manner. For example, each of the communication devices 121 can be implemented as communication hardware, communication software, or a combination of communication hardware and communication software; each of the communication devices 122 can be implemented as communication hardware, communication software, or a combination of communication hardware and communication software; the wireless access point 131 can be implemented as wireless access point hardware, wireless access point software, or a combination of wireless access point hardware and wireless access point software; the wireless access point 132 can be implemented as wireless access point hardware, wireless access point software, or a combination of wireless access point hardware and wireless access point software; gateway resource 151 can be implemented as gateway hardware, gateway software, or a combination of gateway hardware and; communication management resource 140 can be implemented as communication management hardware, communication management software, or a combination of communication management hardware and communication management software; portal resource 141 can be implemented as portal hardware, portal software, or a combination of portal hardware and portal software; and so on.

### Further Examples

1. Two networks (LANs such as network 201 and network 202) may belong to two different tenants of an MDU (Multiple Dwelling Unit). The multi-dwelling unit may include 2 apartments, where a first apartment is basically the subscriber domain 161 and a second apartment is the subscriber domain 162. Each of these networks can be configured to maintain its own layer 2 broadcast domain and private subnet (maintained by the BNG or gateway resource 151). The wireless access point such as CPE or other suitable entity installed at the tenant location in subscriber domain 161 acts as a tunneling bridge, forwarding layer 2 frames to the BNG over a respective GRE tunnel such as communication path 111 for network 201 and communication path 112 for network 202.
2. Wireless access point 131 operates in the subscriber domain 161 and provides the respective communication devices 121 access to the remote network 190. Accordingly, the wireless access point 131 belongs to the tenant (such as user 108) in the subscriber domain 161.
3. Wireless access point 132 operates in the subscriber domain 162 and provides the respective communication devices 122 access to the remote network 190. Accordingly, the wireless access point 132 belongs to the tenant (such as user 109) in the subscriber domain 162.
4. The Broadband Network Gateway such as gateway resource 151 is in control of the User Plane; the gateway resource 151 may serve as a termination point associated with the networks 201 and 202. Further, the gateway resource 151 and corresponding network address translator resource 171 serve as the router/NAT point for the connected tenant networks 201 and 202. In this example, the ‘user plane’ associated with the gateway resource 151 is directly in line with and processes the subscriber traffic (data packets outbound from the networks or inbound to the network), enabling the different communication devices access to the network 190 through the gateway resource 151.
5. The Broadband Network Gateway—Control Plane such as the network 149—supports the management function (communication management resource 140) for the BNG-UP (user plane associated with the gateway resource 151). The communication management resource 140 transmits instructions to or over the BNG-UP (Broadband Network Gateway-User Plane) and makes calls to various back office functions (such as subscriber information 185) on behalf of the BNG-UP. The subscriber information 185 indicates attributes of the different users and subscriber domains as well as wireless access points.
6. The portal resource 141 serves as or is a so-called subscriber-facing portal. As further discussed herein, the portal resource 141 enables the tenants (such as user 108, user 109, etc.) of each respective subscriber domain the ability to manage their services, and—for the purposes as discussed herein—request establishment of a ‘remote LAN connection’ such as including communication path 113 between networks or communication devices. Note that the remote LAN connection may be another communication path independent of the communication paths 111, 112, 113. The portal resource 141 can be configured to communicate a tenant's intent/service request to both the subscriber database and the BNG-CP (including the communication management resource 140).
7. The Subscriber Database such as storing subscriber information 185 can be configured to maintain various types of information such as billing information/subscriber information associated with the one or more users 108, 109, etc., to allow for the identification and status of a subscriber account.

Further in this example, assume that the tenant such as the user 108 in the subscriber domain 161 would like to play a LAN game (first application executed on the communication device 121-1) with the tenant (such as user 109) in the subscriber domain. The user 109 also executes the first application on the communication device 122-1. In such an instance, to support communications between the executed first application on the communication device 121-1 and the executed first application on the communication device 122-1, the tenant (user 108) in the subscriber domain 161 invites the tenant (user 109) to join the network 201 (network created by the user 108) or at least have access to the mobile communication device 121-1.

The invitation as discussed herein by the user 108 to the user 109 may include the user 108 logging into the portal resource 141 (such as via communications from the mobile communication device 121-1 through or over one or more of the wireless access point 131, communication path 111, network 149). After logging in, the communication device 121-1 and/or corresponding user 108 notify the portal resource 141 regarding the desire to invite the user 109 and corresponding communication device 122-1 to become a member of the network 201 or at least have access to communicating directly with the mobile communication device 121-1 as if it were in the same network as the mobile communication device 122-1. Thus, in one example, the user 109 and corresponding communication device 122-1 is basically a visitor invited into the network 201. The user 108 is a host associated with the network 201.

As further discussed herein, the implementation of the communication path 113 (such as a virtual link or virtual tunnel) enables the subscriber 109 and corresponding one or more communication devices 122 to become members of the network 201 or at least have a direct connection to the mobile communication device 121-1. Conversely, if desired, the user 108 may become a member of the network 202 associated with the user 109 and corresponding subscriber domain 162 or at least have a direct connection to the mobile communication device 122-1.

The following drawings and description provide a step-by-step operation associated with establishing the communication path 113, bypassing the need to use remote network 190 to connect the first network 201 and corresponding one or more communication devices 121 to the second network 202 and corresponding communication devices 122. Additionally, the following drawings and description illustrate how member communication devices in each of the different networks can be a member of the other network or at least have access to each other as though such devices were in the same network.

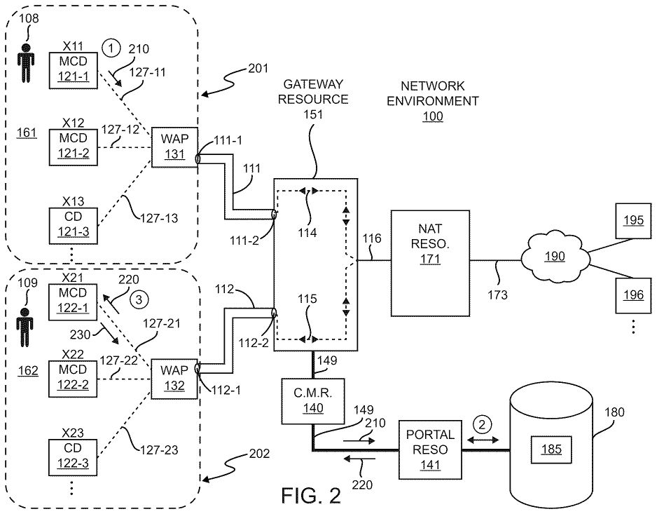

FIG. 2 is an example diagram illustrating an initial invitation by a first user in a first wireless network for a second user in the second wireless network to join the first wireless network as discussed herein.

As previously discussed, the network environment 100 includes communication path 111 disposed between the wireless access point 131 and the gateway resource 151. Via communications over the wireless communication links 127, and corresponding conveyance of data packets through the wireless access point 131 and the communication path 111 (such as a communication link), each of the communication devices 121 is in communication with the gateway resource 151. The gateway resource 151 further provides the communication devices 121 access to the remote network 190.

The network environment 100 also includes communication path 112 such as a communication link disposed between the wireless access point 132 and the gateway resource 151. Via communications over the wireless communication links 127, and corresponding conveyance of data packets through the wireless access point 132 and the communication path 112, each of the communication devices where 22 is in communication with the gateway resource 151. The gateway resource 151 further provides the communication devices 122 access to the remote network 190.

Further in this example, in processing operation #1, the user 108 operates the communication device 121-1 to send an invite to the communication device 122-1 and corresponding user 109 to become a member of the network 201 or at least have direct access of communications with the communication device 121-1. The invitation may include the user 108 and corresponding communication device 121-1 selecting to invite the visitor (user 109 and corresponding communication device 122-1) by notifying the portal resource 141 of their identities via communications 210. The identities can be or include any suitable information such as email address of the user 109 operating the communication device 122-1, network address X21 assigned to the communication device 122-1, etc. The communications 210 can be configured to indicate the desired entity such as the communication device 122-1 or the user 109 by email address registered to the user 109. In other words, via communications 210 in processing operation #1 transmitted by the communication device 121-1 to the portal resource 141, the portal resource 141 is informed of the entity such as communication device 122-1 to be sent the invitation.

In one example, in processing operation #2, in response to receiving the request (communications 210) to generate an invitation, the portal resource 141 can be configured to notify the user 108 and corresponding communication device 121-1 to provide unique identity information associated with the invited one or more entities to be provided access to the network 201 such as at least the unique network address X21 assigned to the mobile communication device 122-1 as a security measure to ensure that only the communication device 122-1 in the network 202 is allowed to join the network 201.

Assume further that the portal resource 141, in processing operation #2, in response to receiving the invitation request in communications 210, transmits a respective notification in communications 220 to the mobile communication device 122-1 regarding the request for the mobile communication device 122-1 and corresponding user 109 to become part of the network 201 or at least have direct access to the mobile communication device 121-1. As previously discussed, the notification and communications 220 can be or include any suitable information. In one example, the communications 220 include an email and corresponding link to be clicked by the host 109 and corresponding communication device 122-1 to confirm receipt of the invitation from the user 108. In one example, the portal resource 141 produces the email and corresponding link after the portal resource 141 checks and validates that both the communication device 121-1 corresponding user 108 as well as the communication device 122-1 and corresponding user 109 have valid accounts associated with the network service provider operating the wireless access point 131, wireless access point 132, and gateway resource 151. Thus, after it is determined that both user 108 and user 190 have the right to use the service provider's network in a manner as requested by the mobile communication device 121-1, the portal resource 141 transmits the invitation notification in communications 220 to the communication device 122-1 or potentially other communication devices in the network 202.

In processing operation #3, the mobile communication device 122-1 receives the invitation (communications 220) from the portal resource 141 for the communication device 122-1 to join the network 201.

Further in processing operation #3, assume that the user 109 operates the communication device 122-1 to accept the invitation to become a member of the network 201 or lease have direct access mobile communication device 121-1 as if the mobile communication device 122-1 was a member of the network 201, facilitating connectivity of the first wireless access point 131 and the second wireless access point 132 at the gateway resource 151. The portal resource 141 or other suitable entity receives the communications 230 indicating the desire by the user 109 and corresponding communication device 122-1 to become a member of the wireless network 201.

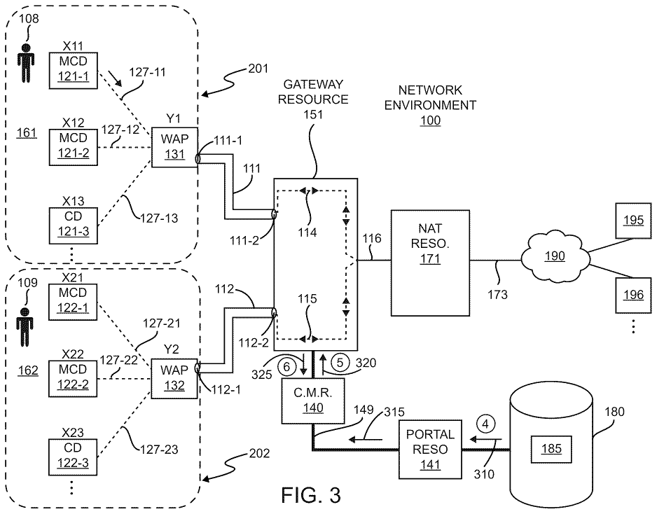

FIG. 3 is an example diagram illustrating retrieval of subscriber information and network connection information associated with the first wireless access point and the second wireless access point to establish a bridge connection as discussed herein.

In processing operation #4, upon receiving notification from the user 109 and corresponding communication device 122-1 to join the network 201 or lease to provide the mobile communication device 122-1 direct communications access through a combination of the wireless access point 132, gateway resource 151, and the wireless access point 131, the portal resource 141 communicates with the communication management resource 140 and the repository 180 to indicate/validate the acceptance to join the communication device 122-1 to the network 201. This may include one or more further operations.

In processing operation #4, the repository 108 provides notification (communications 310) of account information associated with the user 108 as well as account information associated with use of 109. In one example, the account information indicates any suitable information such as attributes of the one or more communication devices operated by the user 109 in the subscriber domain 162, attributes of the one or more communication devices operated by the user 108 scriber domain 161, and any other pertinent information useful to record a new network connection (such as the BNG-CP/BNG-UP that is hosting the network, the WiFi CPE of the tenants, etc.) between the end point 111-2 associated with the communication path 111 and the end point 112-2 associated with the communication path 112.

Further, via communications 315, the BNG-CP (control plane) message instructs the control plane and communication management resource 140 to communicate, to the BNG-UP, the identities of the two networks (201 and 202) that are of concern to the service, as well as the MAC address such as X21 associated with the communication device 122-1 that is going to ‘join’ to the host network 201 can be given access to the mobile communication device 120-1 assigned the network address X11.

In a further example, via communications 325 in processing #6, the communication management resource 140, such as implementing or controlling the BNG-CP (Broadband Network Gateway-Control Plane) associated with the gateway resource 151, retrieves the following information from the BNG-UP: i) the Globally Unique Address (such as the unique identifier value Y1 assigned to the wireless access point 131 and the unique identifier value Y2 assigned to the wireless access point 132) of both WiFi CPE (IPv6), and ii) the MAC address (such as unique identifier value X21) assigned to the of the visitor's device such as communication device 122-1.

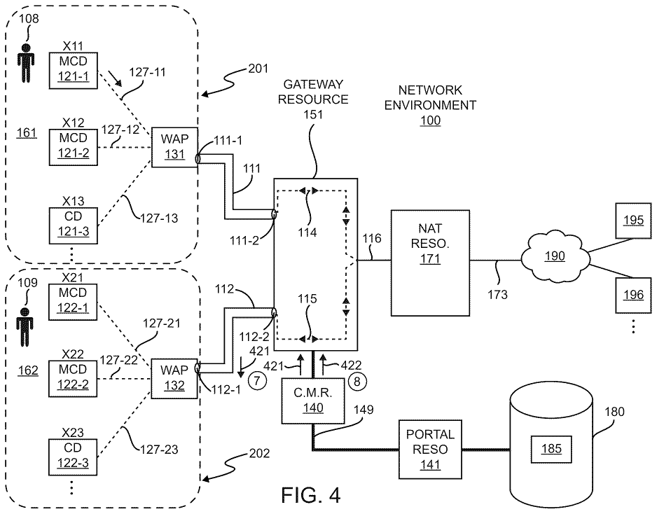

FIG. 4 is an example diagram illustrating communications of instructions to a gateway in order to support connectivity of the first wireless access point and the second wireless access point as discussed herein.

In processing operation #7, the communication management resource 140 communicates instructions (communications 421) to the gateway resource 141 (BNG-CP) to the BNG-UP associated with the gateway resource 151 to perform one or more of the following actions: i) notify the wireless access point 132 (visitor access point) to instantiate a second bridge interface in the network 202 and include the communication device 122-1 (such as the visitor's laptop) to that interface. In one example, the instantiation of the second bridge interface in the network 202 is with respect to the wireless access point 132 and places the visitor laptop (communication device 122-1) on its own broadcast domain within the visitor's AP (131), separate from all the other devices (communication devices 122-2, 122-3, etc.) connected to the visitor's LAN (network 202).

Note that the so-called second bridge interface in the network 202 can be implemented in any suitable manner. As discussed herein, the gateway resource 151 can be configured to establish a third communication path between the first communication path 111 and the second communication path 112 in the gateway resource 151. Alternatively, the communication management resource 140 and corresponding gateway resource 151 can be configured to establish a completely different and independent communication path between the wireless access point 132 through the gateway resource 151 to the wireless access point 131. Such a second bridge interface enables the mobile communication device 122-1 to discover availability of the mobile communication device 121-1 as if the mobile communication device 121-1 was disposed in the network 202.

In processing operation #8, the communication management resource 140 notifies the gateway resource 151 to accept the new connection request from the wireless access point 132 on behalf of the mobile communication device 122-1. Note that communications from the wireless access point 132 to the gateway resource 141 may indicate attributes of a respective separate or independent bridge interface (such as second bridge interface as previously discussed) to which the communication device 122-1 is connected via a unique VLAN tag received over the tunnel 112 from the wireless access point 132.

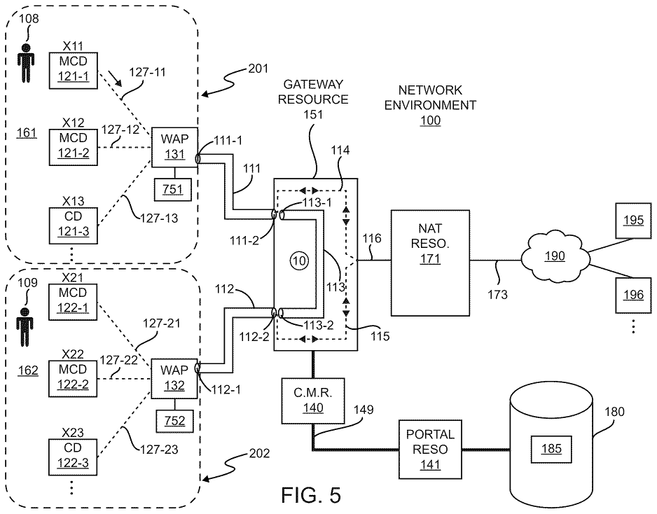

FIG. 5 is an example diagram illustrating implementation of a bridge connection supporting connectivity between multiple different wireless networks as discussed herein.

In this example, in processing operation #10, in response to receiving instructions from the communication management resource 140 or other suitable entity to support the connectivity between the mobile communication device 122-1 and the mobile communication device 121-1 (or between networks as previously discussed), the gateway resource 151 establishes a bridge connection such as communication path 113 between the wireless access point 131 and the wireless access at 132. In one example, the communication path 113 such as a bypass path supports rate-limited layer 2 data packet traffic conveyed between the communication device 122-1 and any target device such as communication device 121-1 in the network 201.

As previously discussed, the implementation of the communication path 113 is shown by way of non-limiting example. Alternative as discussed herein include establishing a respective independent (supplemental) communication path from the wireless access point 132 through the gateway resource 151 to the wireless access point 131, where the independent communication supports connectivity between the mobile communication device 122-1 and the mobile communication device 121-1. The gateway resource 151 can be configured to establish the independent communication path and support a corresponding forwarding function such that the mobile communication device 121-1 appears at least to the mobile communication device 122-1 that the mobile communication device 121-1 is a member of the network 202 or the mobile communication device 121-1 at least has access to the mobile communication device 121-1, even though the mobile communication device 121-1 resides in network 201 and the mobile communication device 122-1 resides in the network 202.

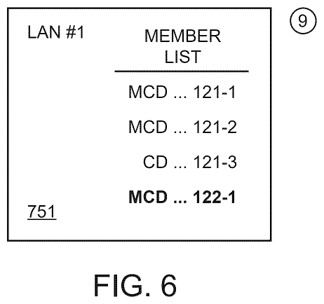

FIG. 6 is an example diagram illustrating inclusion of the mobile communication device in the second wireless network as a member of the first wireless network as discussed herein.

As previously discussed, the communication device 122-1 may be considered a member of the (host) network 201 for at least have access to the communication device 121-1, which allows for DHCP/DHCPv6/SLAAC services as well as NAT/Internet access. Note further that ARPs also may be allowed to support discovery of the host LAN (201) for at least the mobile communication device 121-1 by the communication device 122-1. Thus, via communications from the mobile communication device 122-1 to the wireless access point 132, the mobile communication device 122-1 may discover the availability of the network 201 and potentially other communication devices in the network 201 to which the mobile communication device 122-1 may have direct access as if the discovered devices were disposed in the network 201.

Further, as previously discussed, the mobile communication device 122-1 may have only limited access to discovering the mobile communication device 121-1 in the network 201. In such an instance, mobile communication device 122-1 can be configured to generate a discovery request to the wireless access point 132 to determine any available devices. In response to the discovery request, the mobile communication device 122-1 learns of all of the communication devices in the network 202 as well as the availability of at least the mobile communication device 121-1 in network 201 due to the invitation and acceptance by the mobile communication device 122-1.

In general, the Address Resolution Protocol (ARP) is a communication protocol used for discovering the link layer address, such as a MAC address, associated with a given internet layer address, typically an IPv4 address. This mapping is a useful function in the Internet protocol suite to discover other communication devices accessible by the inquiring communication device. Thus, in one example, via discovery as discussed herein, the mobile communication device 122-1 is able to detect availability of the mobile communication device 121-1, and potentially vice versa if the mobile communication device 121-1 is provided reciprocal access.

In one example, the communication device 122-1 can be configured to discover that mobile communication device 121-1 is accessible via a response from the mobile communication device 121-1. This can include the mobile communication device 122-1 transmitting a discovery message to the wireless access point 132 and then receiving a response from the mobile communication device 121-1 or response from the communication from the wireless access point 132, where the response includes the corresponding network address X11 associated with the mobile communication device 121-1 as a reachable entity.

Note again that the mobile communication device 122-1 may be restricted to only communicating with the mobile communication device 121-1 in the network 201, where other devices such as communication device 121-2, 121-3, etc., cannot be seen or discovered by the mobile communication device 122-1, assuming that the communication device 122-1 is not granted authority by the user 108 to view all communication devices in the network 201. Thus, when the wireless access point 131 receives a discovery request message from the mobile communication device 122-1, the wireless access point 131 or other entity may restrict the mobile communication device 122-1 from seeing or receiving a discovery response from entities other than the mobile communication device 121-1.

The discovery of the mobile communication device 121-1 can be supported in any suitable manner. In one example, the mobile communication device 122-1 generates a respective discovery message communicated over the wireless communication link 127-21 to the wireless access point 132. The wireless access point 132 can be configured to forward the discovery request over a combination of the communication path 112, communication path 113, communication path 111, to the wireless access point 131. The wireless access point 131 may further communicate the discovery request to the mobile communication device 121-1 over the wireless communication link 127-11. The mobile communication device 121-1 may respond with its assigned network address X11, where the response communication is transmitted over a wireless communication link 127-11, through the combination of wireless access point 131, communication at 111, communication path 113, communication path 112, and wireless access point 132, and over wireless communication link 127-21 to the mobile communication device 122-1.

Other ways of the mobile communication device 122-1 discovering the availability of the mobile communication device 121-1 are possible as well.

Subsequent to discovery of the communication device 121-1 by the communication device 122-1, in order to communicate with the mobile communication device 121-1, the mobile communication device 122-1 produces one or more data packets including the destination network address X11, which is then delivered via conveyance through a combination of resources including the wireless access point 132, communication path 112, communication path 113, communication path 111, and wireless access point 131. In other words, the mobile communication device 122-1 communicates the one or more data packets including the destination network address X11 to the wireless access point 132. The wireless access point 132 forwards the one or more data packets through the communication path 112 to the gateway resource 151. The gateway resource 151 such as configured with L2 routing capability has control of the broadcast domain associated with conveying communications (data packets) between the mobile communication device 122-1 and the mobile communication device 121-1. In other words, the gateway resource 151 may be or include functionality such as a layer 2 routing functionality supporting conveyance of the data packets. Effectively, the newly established connectivity as discussed herein provides a similar function as the mobile communication device 122-1 plugging itself directly into one of the switch ports of the mobile communication device 121-1. Thus, the gateway resource 151 receives the one or more data packets destined for delivery to the mobile communication device 121-1. In such an instance, the gateway resource 151 forwards the received one or more data packets over the communication path 111 and corresponding wireless access at 131 to the mobile communication device 121-1.

In a similar manner, the mobile communication device 121-1 can be configured to transmit communications (such as data packets) to the mobile communication device 122-1 over a combination of the wireless communication link 127-11, wireless access point 131, communication path 111, communication path 113, communication path 112, wireless access point 132, and wireless communication link 127-21. As previously discussed, the unique overall connection path including the communication path 111, communication path 113, and communication path 112 alleviates the need for the data packets to the transmitted over the network 190.

Accordingly, via the communication path 113, the communication management resource 140 establishes a respective overall communication link between the wireless access point 132, gateway resource 151, and the wireless access point 131 to support layer 2 conveyance of communications between the mobile communication device 122-1 and the mobile communication device 121-1 in the network 201.

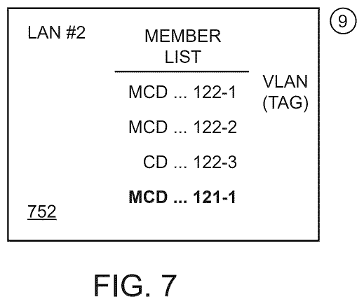

FIG. 7 is an example diagram illustrating inclusion of a mobile communication device in the first wireless network as a member of the second wireless network as discussed herein.

As previously discussed, the acceptance by the mobile communication device 122-1 to become a member of the network 201, or at least have access to the mobile communication device 121-1, may further include the mobile communication device 121-1 becoming a member of the network 202 for at least have access to the mobile communication device 122-1. If desired, the network 202 or other suitable entity can be configured to track that the communication device 121-1 is a member of the network 202 or at least that the communication device 121-1 has access to the mobile communication device 122-1.

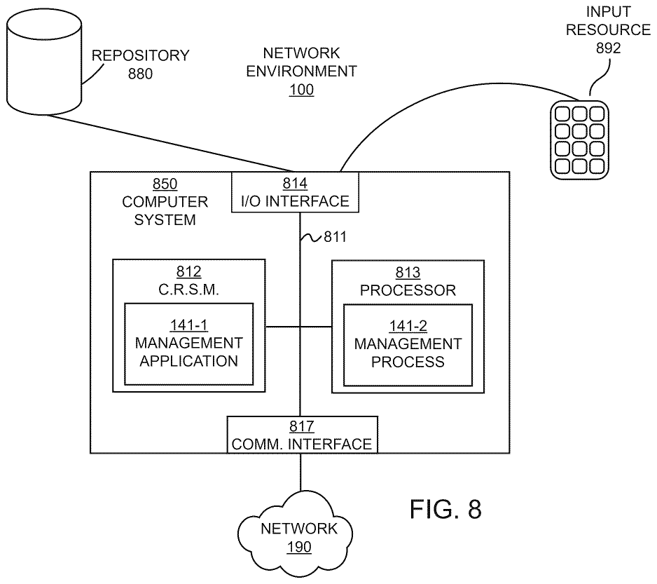

FIG. 8 is an example block diagram of a computer system for implementing any of the operations as previously discussed according to examples herein.

Note that any of the resources (such as any of the mobile communication devices 121, mobile communication devices 122, wireless access point 131, wireless access point 132, gateway resource 151, communication management resource 140, portal resource 141, etc.) as discussed herein can be configured to include computer processor hardware and/or corresponding executable instructions to carry out the different operations as discussed herein.

For example, as shown, computer system 850 of the present example includes interconnect 811 coupling computer readable storage media 812 such as a non-transitory type of media, or computer readable storage hardware (which can be any suitable type of resource in which digital information can be stored and or retrieved), a processor 813 (computer processor hardware), I/O interface 814, and a communications interface 817.

I/O interface(s) 814 supports connectivity to repository 880 and input resource 892.

Computer readable storage medium 812 such as computer readable hardware can be any hardware storage device such as memory, optical storage, hard drive, floppy disk, etc. In one example, the computer readable storage medium 812 stores instructions and/or data.

As shown, computer readable storage media 812 can be encoded with communication management application 140-1 to carry out any of the operations as discussed herein.

During operation of one example, processor 813 accesses computer readable storage media 812 via the use of interconnect 811 in order to launch, run, execute, interpret or otherwise perform the instructions in management application 140-1 stored on computer readable storage medium 812. Execution of the communication management application 140-1 produces communication management process 140-2 to carry out any of the operations and/or processes as discussed herein.

Those skilled in the art will understand that the computer system 850 can include other processes and/or software and hardware components, such as an operating system that controls allocation and use of hardware resources to execute the management application 140-1.

In accordance with different examples, note that computer system may reside in any of various types of devices, including, but not limited to, a mobile computer, a personal computer system, a wireless device, a wireless access point, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 850 may reside at any location or can be included in any suitable resource in any network environment to implement functionality as discussed herein.

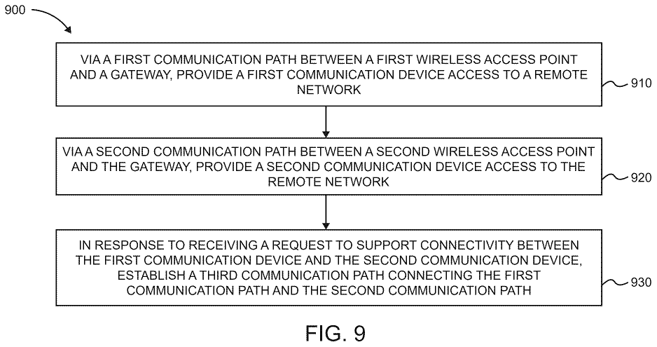

Functionality supported by the different resources will now be discussed via flowchart 900 in FIG. 9. Note that the operations in the flowchart below can be executed in any suitable order.

FIG. 9 is a flowchart 900 illustrating an example method according to examples herein. Note that there will be some overlap with respect to concepts as discussed above.

In processing operation 910, the first communication path 111 between the wireless access point 131 and the gateway resource 151 provides one or more communication devices (121-1, 121-2, 121-3, etc.) in the first wireless network 201 access to a remote network 190 and corresponding server resources 195, 196, etc.

In processing operation 920, the second communication path 112 between the wireless access point 132 and the gateway 151 provides the one or more communication devices (122-1, 122-2, 122-3, etc.) in the second wireless network 202 access to the remote network 190 and corresponding server resources 195, 196, etc.

In processing operation 930, in response to receiving a request to support connectivity between the first communication device 121-1 and the second communication device 122-2, the communication management resource 140 establishes a third communication path 113 (inside or outside the gateway resource 151) connecting the first communication path 111 and the second communication path 112. A virtual pathway through the first communication path, second communication path, and the third communication path provides the communication device 122-1 provides an experience as though the communication device 122-1 was a member of the network 201 or that the communication device 121-1 resides in the network 202. Alternatively, note again that the virtual pathway may provide the communication device 122-1 only access to the communication device 121-1 in the first wireless network 201 as opposed to access to all of the devices in the network 201.

Note again that techniques herein are well suited to provide connectivity amongst communication devices in different virtual local area networks. However, it should be noted that examples herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this example has been particularly shown and described with references to preferred examples thereof, it will be understood by those skilled in the art that various changes in form and details may be made therein without departing from the spirit and scope of the present application as defined by the appended claims. Such variations are intended to be covered by the scope of this present application. As such, the foregoing description of examples of the present application is not intended to be limiting. Rather, any limitations to the invention are presented in the following claims.

I claim:

1. A method comprising:
via a first communication path between a first wireless access point and a gateway, providing a first communication device access to a remote network;
via a second communication path between a second wireless access point and the gateway, providing a second communication device access to the remote network; and
in response to receiving a request to support connectivity between the first communication device and the second communication device, establishing a third communication path connecting the first communication path and the second communication path.

2. The method as in claim 1, wherein the first communication path is a first secure tunnel, where a first endpoint of the first communication path terminates at the first wireless access point and where a second endpoint of the first communication path terminates at the gateway; and
wherein the second communication path is a second secure tunnel where a first endpoint of the second communication path terminates at the second wireless access point and a second endpoint of the second communication path terminates at the gateway.

3. The method as in claim 2, wherein the third communication path is a third secure tunnel having corresponding endpoints in the gateway, the third secure tunnel providing connectivity between the second endpoint of the first communication path and the second endpoint of the second communication path.

4. The method as in claim 1, wherein the first wireless access point, the second wireless access point, and the gateway are part of a service provider network in communication with the remote network through a network address translator; and
wherein the third communication path alleviates a need to convey communications through the remote network to support the connectivity between the first communication device and the second communication device.

5. The method as in claim 1 further comprising:
receiving the request from the first communication device.

6. The method as in claim 1, wherein establishing the third communication path includes:
transmitting an invitation message from a service provider portal through the second communication path and the second wireless access point to the second communication device, the invitation message including an identity of the first communication device and an inquiry to a user of the second communication device whether to provide the connectivity between the second communication device and the first communication device.

7. The method as in claim 1, wherein the third communication path supports conveyance of layer 2 communications between the first communication path and the second communication path, the layer 2 communications by passing the remote network and supporting conveyance of data between the first communication device and the second communication device.

8. The method as in claim 1, wherein the first wireless access point supports a first virtual local area network including the first communication device as a first member; and
wherein the second wireless access point supports a second virtual local area network including the second communication device as a first member.

9. The method as in claim 8, wherein the first wireless access point is configured to track the second communication device as a second member of the first virtual local area network; and
wherein the second wireless network is configured to track the first communication device as a second member of the second virtual local area network.

10. The method as in claim 1, wherein the first wireless access point is configured to produce network information indicating members of a local area network supported by the first wireless access point, the members including the first communication device and the second communication device.

11. A system comprising:
communication management hardware operative to:
via a first communication path between a first wireless access point and a gateway, provide a first communication device access to a remote network;
via a second communication path between a second wireless access point and the gateway, provide a second communication device access to the remote network; and
in response to receiving a request to support connectivity between the first communication device and the second communication device, establish a third communication path connecting the first communication path and the second communication path.

12. The system as in claim 11, wherein the first communication path is a first secure tunnel, where a first endpoint of the first communication path terminates at the first wireless access point and where a second endpoint of the first communication path terminates at the gateway; and
wherein the second communication path is a second secure tunnel where a first endpoint of the second communication path terminates at the second wireless access point and a second endpoint of the second communication path terminates at the gateway.

13. The system as in claim 12, wherein the third communication path is a third secure tunnel having corresponding endpoints in the gateway, the third secure tunnel providing connectivity between the second endpoint of the first communication path and the second endpoint of the second communication path.

14. The system as in claim 11, wherein the first wireless access point, the second wireless access point, and the gateway are part of a service provider network in communication with the remote network through a network address translator; and
wherein the third communication path alleviates a need for the gateway to convey communications through the remote network to support the connectivity between the first communication device and the second communication device.

15. The system as in claim 11, wherein the communication manager hardware is further operative to:
receive the request from the first communication device.

16. The system as in claim 11, wherein the communication manager hardware is further operative to:
transmit an invitation message from a service provider portal through the second communication path and the second wireless access point to the second communication device, the invitation message including an identity of the first communication device and an inquiry to a user of the second communication device whether to provide the connectivity between the second communication device and the first communication device.

17. The system as in claim 11, wherein the third communication path supports conveyance of layer 2 communications between the first communication path and the second communication path, the layer 2 communications by passing the remote network and supporting conveyance of data between the first communication device and the second communication device.

18. The system as in claim 11, wherein the first wireless access point supports a first virtual local area network including the first communication device as a first member; and
wherein the second wireless access point supports a second virtual local area network including the second communication device as a first member.

19. The system as in claim 18, wherein the first wireless access point is configured to track the second communication device as a second member of the first virtual local area network; and
wherein the second wireless network is configured to track the first communication device as a second member of the second virtual local area network.

20. The system as in claim 11, wherein the first wireless access point is configured to produce network information indicating members of a local area network supported by the first wireless access point, the members including the first communication device and the second communication device.

21. Computer-readable storage hardware having instructions stored thereon, the instructions, when carried out by computer processor hardware, cause the computer processor hardware to:
via a first communication path between a first wireless access point and a gateway, provide a first communication device access to a remote network;
via a second communication path between a second wireless access point and the gateway, provide a second communication device access to the remote network; and
in response to receiving a request to support connectivity between the first communication device and the second communication device, establish a third communication path in the gateway connecting the first communication path and the second communication path.
